(19) United States
(12) Patent Application Publication
(10) Pub. No.: US 2020/0278054 A1
(43) Pub. Date: Sep. 3, 2020

(54) KIND OF COMPOSITE HOSE

(71) Applicant: Jiaqi WANG, Shangyu City (CN)

(72) Inventor: Jiaqi WANG, Shangyu City (CN)

(21) Appl. No.: 16/377,611

(22) Filed: Apr. 8, 2019

(30) Foreign Application Priority Data
Feb. 28, 2019 (CN) 201910148160.3

(51) Int. Cl. F16L 11/08; F16L 33/01; F16L 33/207

(52) U.S. Cl. CPC F16L 11/08; B32B 7/12; F16L 33/2071; F16L 33/01

(57) ABSTRACT

The invention discloses a kind of composite hose, comprising composite hose body composed of outer hose body, middle hose body and inner hose body.

The composite hose body is provided with hose connection clamp and plastic claw fastener on both end caps, advantageous for use convenience, good airtightness, no breakage of hose body when bending and extension of service life of hose body.

### TECHNICAL FIELD

The invention relates to hose technical field, in particular to a kind of composite hose.

### BACKGROUND ART

The hose is usually made of natural or synthetic fiber, rubber, thermoplastic rubber and other materials. There are the following problems in use: the traditional hose can connect with the hose connection clamp to form different diameter conversion, convenient for use, but may be damaged because of using single-layer wall easy to be broken by sharp objects such as stones when dragging on the ground; in addition, the traditional hose connection clamp is subject to water leakage while in use.

### SUMMARY

The purpose of the invention is to provide a composite hose for the defects and deficiencies in prior art.

The inventive composite hose comprises composite hose body including outer hose body, middle hose body coaxial with the outer hose body and inner hose body coaxial with the middle hose body; wherein the middle hose body arranged on the inner wall of the outer hose body is provided with inner hose body on its inner wall, thereby forming the composite hose body by adhesive;

The end cap of the composite hose body is provided with hose connection clamp and sheathed with plastic claw fastener that is mounted in screw cap of the hose connection clamp;

The inner wall of the outer hose body is smooth;

The middle hose body has smooth outer wall and bellow-typed inner wall on which there are uniformly arranged with several inner wall stiffeners I along axial direction of middle hose body;

The inner hose body has smooth outer wall and bellow-typed inner wall on which there are uniformly arranged with several inner wall stiffeners II along axial direction of middle hose body;

There are several arc groove cavities filled with adhesive between inner hose body and bottom of inner wall stiffeners I of the middle hose body, so that the inner hose body is tightly bonded with the middle hose body.

Further, the inner wall stiffeners I and the inner wall stiffeners II have a circular cross section.

Further, there are uniformly provided with several longitudinal line protrusions or coated with ribbed protruding ribs around outer surface of the outer hose body in direction of the hose body.

Further, the outer hose body and the middle hose body are made by PPE materials, and the inner wall stiffeners I and the inner wall stiffeners II are made by terylene.

Further, the plastic claw fastener comprises frustum-shaped casing being equipped with retractable gap and several clearances to form several arc fastening plates whose lower inner walls are provided with arc convex platforms, forming annular platform with inner diameter fitting with diameter of the composite hose body; the upper parts of the several arc fastening plates form annular groove fitting with inner diameter of screw cap.

Further, the hose connection clamp comprises annular plate whose front is provided with orifice sheathed with retractable sleeve and rear is provided with convex cylinder around which there are several convex plates and below which there is provided with thread mouth; the lateral sides of the several convex plates are provided with external thread fitting to the bottom thread mouth of the convex cylinder whose bottom surface is provided with cylindrical clamp being wedged in the middle hose body of composite hose; the convex cylinder is screwed with screw cap whose inner wall is provided with internal thread fitting to the external thread of convex cylinder; the bottom end of the screw cap is fit with the composite hose body.

Further, the cylindrical clamp comprises cylindrical hose body in straight cylindrical shape whose lateral end is frustum-shaped opening and one side is provided with annular groove being sheathed with leather sleeve on which the bottom of several arc fastening plates on the plastic claw fastener is fastened; the cylindrical clamp has openings on both ends and water guide channel in the interior.

By above structure, the beneficial effects of the invention are as follows: the composite hose in the invention is made by setting several reinforced protruding ribs on two inner walls of composite hose body in three layers, and then installing plastic claw fastener on orifice of the composite hose body, convenient for be fastened on the hose connection clamp, advantageous for use convenience, good airtightness, no breakage of hose body when bending and extension of service life of hose body.

### DESCRIPTION OF DRAWINGS

The drawings herein used for further understanding of the invention constitute a part of the present invention but not as improper limitation, wherein:

FIG. 1 is a structural schematic view of the invention;

FIG. 2 is a perspective structural schematic view of the present invention with exception of screw cap;

FIG. 3 is a cross-sectional structural view of middle hose body in the present invention;

FIG. 4 is a perspective structural schematic view of plastic claw fastener in the invention;

FIG. 5 is a schematic top view of plastic claw fastener in the invention;

FIG. 6 is a cross-sectional structural view of the composite hose body in the invention;

FIG. 7 is a structural schematic view of cylindrical clamp in the invention.

### DESCRIPTION OF REFERENCE SIGNS IN DRAWINGS

1. hose connection clamp; 11. retractable sleeve; 12. orifice; 13. annular plate; 14. screw cap; 15. cylindrical clamp; 151. cylindrical hose body; 152. leather sleeve; 153. frustum-shape opening; 154. water guide channel; 16. convex cylinder; 17. convex plate; 2. composite hose body; 21. outer hose body; 211. longitudinal line protrusion; 22. middle hose body; 221. inner wall stiffeners I; 23. inner hose body; 231. inner wall stiffeners II; 24. arc groove cavity; 3. plastic claw fastener; 31. frustum-shaped casing; 32. clearance; 33. arc fastening plate; 331. arc convex platform; 34. retractable gap.

### [Specific Implementation Method]

Hereinafter, the present invention will be described in detail by drawings accompanying with specific embodiments, wherein the illustrative embodiments and description are only used for purpose of explanation but not intended to limitation.

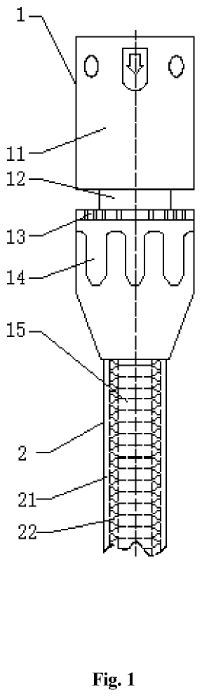

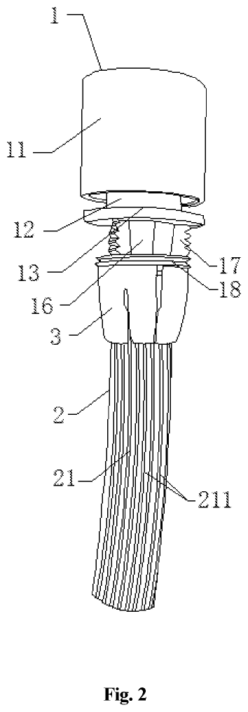

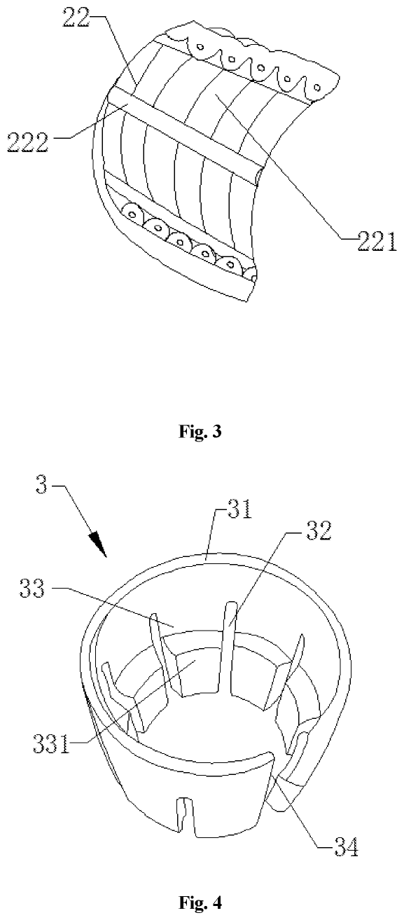

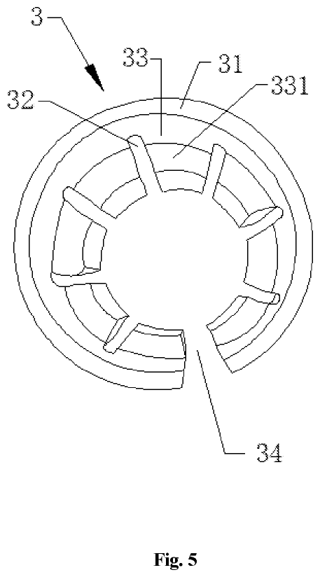

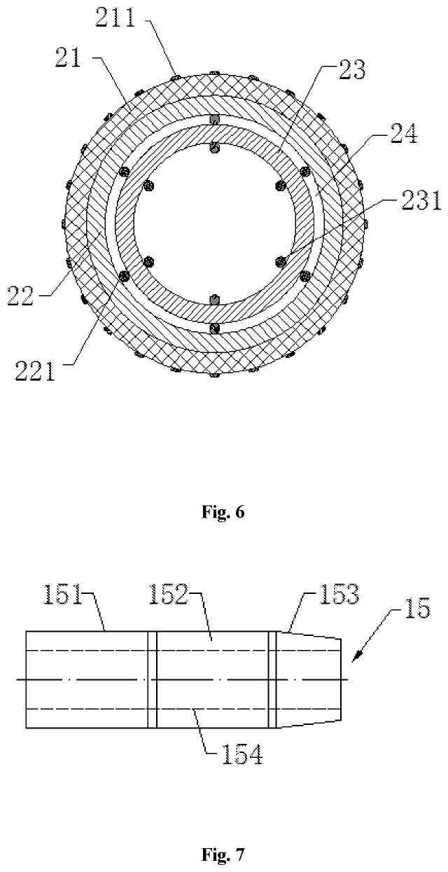

As shown in FIG. 1-7, the composite hose in the embodiment of the present invention comprises composite hose body 2 including outer hose body 21, middle hose body 22 coaxial with the outer hose body 21 and inner hose body 23 coaxial with the middle hose body 22; wherein the middle hose body 22 arranged on the inner wall of the outer hose body 21 is provided with inner hose body 23 on its inner wall, thereby forming the composite hose body by adhesive;

The end cap of the composite hose body is provided with hose connection clamp 1 and sheathed with plastic claw fastener 3 that is mounted in screw cap 14 of the hose connection clamp 1.

The inner wall of the outer hose body 21 is smooth;

The middle hose body 22 has smooth outer wall and bellow-typed inner wall on which there are uniformly arranged with several inner wall stiffeners I 221 along axial direction of middle hose body;

The inner hose body 23 has smooth outer wall and bellow-typed inner wall on which there are uniformly arranged with several inner wall stiffeners II 231 along axial direction of middle hose body;

There are several arc groove cavities 24 filled with adhesive between inner hose body 23 and bottom of inner wall stiffeners I 221 of the middle hose body 23, so that the inner hose body 23 is tightly bonded with the middle hose body 22.

Further, the inner wall stiffeners I 221 and the inner wall stiffeners II 231 have a circular cross section.

Further, there are uniformly provided with several longitudinal line protrusions 211 or coated with ribbed protruding ribs around outer surface of the outer hose body 21 in direction of the hose body.

Further, the outer hose body 21 and the middle hose body 22 are made by PPE materials, and the inner wall stiffeners I 221 and the inner wall stiffeners II 231 are made by terylene.

Further, the plastic claw fastener 3 comprises frustum-shaped casing 31 being equipped with retractable gap 34 and several clearances 32 to form several arc fastening plates 33 whose lower inner walls are provided with arc convex platforms 331, forming annular platform with inner diameter fitting with diameter of the composite hose body; the upper parts of the several arc fastening plates 33 form annular groove fitting with inner diameter of screw cap 14.

Further, the hose connection clamp 1 comprises annular plate 13 whose front is provided with orifice 12 sheathed with retractable sleeve 11 and rear is provided with convex cylinder 16 around which there are several convex plates 17 and below which there is provided with thread mouth; the lateral sides of the several convex plates 17 are provided with external thread fitting to the bottom thread mouth of the convex cylinder 16 whose bottom surface is provided with cylindrical clamp 15 being wedged in the middle hose body of composite hose; the convex cylinder 16 is screwed with screw cap 14 whose inner wall is provided with internal thread fitting to the external thread of convex cylinder 16; the bottom end of the screw cap 14 is fit with the composite hose body.

Further, the cylindrical clamp 15 comprises cylindrical hose body 151 in straight cylindrical shape whose lateral end is frustum-shaped opening 153 and one side is provided with annular groove being sheathed with leather sleeve 152 on which the bottom of several arc fastening plates 33 on the plastic claw fastener 3 is fastened; the cylindrical clamp 15 has openings on both ends and water guide channel 154 in the interior.

The composite hose body consists of an outer hose body, a middle hose body and an inner hose body when in use. For the composite hose in this design, the middle hose body 22 has bellow-typed inner wall on which there are uniformly arranged with several inner wall stiffeners I 221; the inner hose body 23 has bellow-typed inner wall on which there are uniformly arranged with several inner wall stiffeners II 231 along axial direction of middle hose body. The inner wall stiffeners I 221 and the inner wall stiffeners II 231 are made of terylene, so that the composite hose body is not easy to be bent and broken when in use.

In this design, the cylindrical clamp 15 of the hose connection clamp 1 is inserted into bellow-shaped inner wall of inner hose body of the composite for fitting together, convenient to be tightened.

In order to further fasten the composite hose body with hose connection clamp 1, the end cap of the composite hose is sheathed with plastic claw fastener 3 whose retractable gap 34 on frustum-shaped casing 31 allows the plastic claw fastener 3 retractable (elastic), convenient for fitting on different diameter of composite hose body. The plastic claw fastener 3 is frustum-shaped, and opened at both ends, one of which is fit with screw cap of the hose connection clamp 1 and the other of which is fit with diameter of the composite hose body. Since the plastic claw fastener 3 is made by flexible plastic, so that the annular platform on lower inner wall is fastened on the composite hose body. The bottom of several arc fastening plates 33 of the plastic claw fastener 3 is fastened on the leather sleeve 152, reinforcing sealability of hose body and preventing water leakage.

The plastic claw fastener 3 is sleeved on the end of the composite hose body, then sheathed with screw cap, afterwards fixed on convex cylinder 16 of the hose connection clamp 1 by screwing for fastening.

The above description is only the preferred embodiment of the present invention, so all equivalent changes and modifications made in accordance with configuration, characteristics and principles within scope of the patent application are included in the scope of the present invention.

1. A kind of composite hose comprising composite hose body (2) is characterized in that the composite hose body (2) includes outer hose body (21), middle hose body (22) coaxial with the outer hose body (21) and inner hose body (23), wherein the middle hose body (22) arranged on the inner wall of the outer hose body (21) is provided with inner hose body (23) on its inner wall, thereby forming the composite hose body by adhesive.
The end cap of the composite hose body is provided with hose connection clamp (1) and sheathed with plastic claw fastener (3) that is mounted in screw cap (14) of the hose connection clamp (1).
The inner wall of the outer hose body (21) and the outer wall of the middle hose body (22) are smooth; the inner wall of the middle hose body (22) is bellow-typed, on which there are uniformly arranged with several inner wall stiffeners I (221) along axial direction of middle hose body. The inner hose body (23) has smooth outer wall and bellow-typed inner wall on which there are uniformly arranged with several inner wall stiffeners II (231) along axial direction of middle hose body. There are several arc groove cavities 24 filled with adhesive between inner hose body (23) and bottom of inner wall stiffeners I (221) of the middle hose body (22), so that the inner hose body (23) is tightly bonded with the middle hose body (22).

2. The composite hose of claim 1 is characterized in that the inner wall stiffeners I (221) and the inner wall stiffeners II (231) have a circular cross section.

3. The composite hose of claim 1 is characterized in that there are uniformly provided with several longitudinal line protrusions (211) or coated with ribbed protruding ribs around outer surface of the outer hose body (21) in direction of the hose body.

4. The composite hose of claim 1 is characterized in that the outer hose body (21) and the middle hose body (22) are made by PPE materials, and the inner wall stiffeners I (221) and the inner wall stiffeners II (231) are made by terylene.

5. The composite hose of claim 1 is characterized in that the plastic claw fastener (3) comprises frustum-shaped casing (31) being equipped with retractable gap (34) and several clearances (32) to form several arc fastening plates (33) whose lower inner walls are provided with arc convex platforms (331), forming annular platform with inner diameter fitting with diameter of the composite hose body; the upper parts of the several arc fastening plates (33) form annular groove fitting with inner diameter of screw cap (14).

6. The composite hose of claim 1 is characterized in that the hose connection clamp (1) comprises annular plate (13) whose front is provided with orifice (12) sheathed with retractable sleeve (11) and rear is provided with convex cylinder (16) around which there are several convex plates (17) and below which there is provided with thread mouth; the lateral sides of the several convex plates (17) are provided with external threads fitting to the bottom thread mouth of the convex cylinder (16) whose bottom surface is provided with cylindrical clamp (15) being wedged in the middle hose body of composite hose; the convex cylinder (16) is screwed with screw cap (14) whose inner wall is provided with internal thread fitting to the external thread of convex cylinder (16); the bottom end of the screw cap (14) is fit with the composite hose body.

7. The composite hose of claim 6 is characterized in that the cylindrical clamp (15) comprises cylindrical hose body (151) in straight cylindrical shape whose lateral end is frustum-shaped opening (153) and one side is provided with annular groove being sheathed with leather sleeve (152) on which the bottom of several arc fastening plates (33) on the plastic claw fastener (3) is fastened; the cylindrical clamp (15) has openings on both ends and water guide channel (154) in the interior.
